(19) United States
(12) Patent Application Publication
(10) Pub. No.: US 2003/0047366 A1
(43) Pub. Date: Mar. 13, 2003

(54) Module for battery and/or other vehicle components

(75) Inventors: Michael G. Andrew, Menomonee Falls, WI (US); Thomas J. Dougherty, Waukesha, WI (US); Glenn W. Andersen, Hartford, WI (US); Scott A. Hansen, Holland, MI (US); Nels R. Smith, Holland, MI (US); Dale S. Di lulio, Grafton, WI (US)

Correspondence Address: FOLEY & LARDNER, 777 EAST WISCONSIN AVENUE, MILWAUKEE, WI, 53202, US

(73) Assignee: Johnson Controls Technology Company

(21) Appl. No.: 10/192,250

(22) Filed: Jul. 10, 2002

Related U.S. Application Data
(60) Provisional application No. 60/304,303, filed on Jul. 10, 2001.

(51) Int. Cl. B60R 16/04

(52) U.S. Cl. 180/68.5

(57) ABSTRACT

A module for use in a vehicle includes a first compartment for containing a battery and a second compartment contiguous to the first compartment for containing a liquid. The second compartment is configured to route the liquid between the second compartment and a vehicle subsystem.

### CROSS-REFERENCE TO RELATED PATENT APPLICATIONS

This application claims priority to U.S. Provisional Patent Application No. 60/304,303, entitled “Module For Battery And/Or Other Vehicle Components” filed Jul. 10, 2001, which is hereby incorporated by reference.

### FIELD

The present invention relates generally to the field of systems or modules for batteries and/or other components or accessories for use in a vehicle such as an automobile. Specifically, the present invention relates to a battery and accessory module that provides for the containment of a battery and one or more fluids, wires, and/or other automobile components.

### BACKGROUND OF THE INVENTION

Vehicle electrical storage batteries, such as lead-acid batteries, are typically provided within a vehicle engine compartment along with a variety of other vehicle components and systems. The battery may provide power for starting, lighting, and ignition applications, and may be used in conjunction with a number of other vehicle applications.

Vehicle batteries may be affected by their surrounding environment. For example, performance may be adversely affected at extremely cold or extremely hot temperatures. It is generally known that various other engine components either radiate heat (e.g., components that have a temperature greater than ambient temperature) or act as a heat sink (e.g., components that have a temperature lower than ambient temperature). Such other components, however, have not conventionally been used in an efficient manner to provide thermal management for a vehicle battery or other components.

Various engine components (e.g., battery trays, fluid reservoirs, etc.) are typically manufactured as separate items and positioned at various locations within vehicle engine compartments and elsewhere. Separate production of these components may result in unnecessarily elevated manufacturing costs, inventory costs, and labor demand for production and installation of the components. Additionally, providing a number of separate components may result in inefficient allocation of space within an engine compartment.

Vehicle manufacturers have increasingly focused on enhancement of aesthetics within vehicle engine compartments. In certain cases, shrouds or covers have been positioned over various components to cover or mask their appearance. Such shrouds or covers may restrict access to the components, however, and do not solve the problem of inefficient component location positioning within vehicle engine compartments.

Accordingly, it would be advantageous to provide a system that provides thermal management of vehicle batteries. It would also be advantageous to utilize thermal characteristics of various engine components to provide thermal management of vehicle batteries. It would further be advantageous to provide a system that houses a vehicle battery and other components and that provides for efficient manufacturing and space allocation within a vehicle engine compartment. It would further be advantageous to provide a system that provides aesthetic appeal to an engine compartment. It would be advantageous to provide a battery module or system having one or more of these or other advantageous features.

### SUMMARY OF THE INVENTION

The present invention relates to a module for use in a vehicle. The module includes a first compartment for containing a battery and a second compartment contiguous to the first compartment for containing a liquid. The second compartment is configured for routing the liquid between the second compartment and a vehicle subsystem.

The present invention further relates to a heat exchange system for a vehicle battery. The heat exchange system includes a first compartment for containing the vehicle battery, a second compartment for containing a first fluid, and a third compartment for containing a second fluid. The second compartment is coupled to the first compartment, and the third compartment is coupled to at least one of the first compartment and the second compartment. At least one of the first fluid and the second fluid provides for heat transfer between the first compartment and at least one of the second compartment and the third compartment.

The present invention also relates to a system for a vehicle battery. The system includes a base comprising means for containing the battery and means for containing a liquid coupled to the means for containing a battery. The system also includes covering means coupled to the base.

The present invention further relates to a battery module. The battery module includes a battery container for containing a vehicle battery and a plurality of compartments. Each of the compartments is adapted to contain a liquid, and at least one of the plurality of compartments is immediately adjacent to the battery container.

### BRIEF DESCRIPTION OF THE DRAWINGS

FIG. 1 is a perspective view of a battery system according to an exemplary embodiment.

FIG. 2 is an exploded perspective view of the battery system shown in FIG. 1.

FIG. 3 is a top plan view a vehicle engine compartment showing an exemplary placement of a battery system according to an exemplary embodiment.

FIG. 4A is a top view of a battery hold-down system included in a battery compartment of the battery system shown in FIG. 1 according to an exemplary embodiment.

FIG. 4B is a side view of a battery hold-down system included in a battery compartment of the battery system shown in FIG. 1 according to an exemplary embodiment.

FIG. 5 is a front elevational view of a baffle provided in a reinforced fluid compartment according to an exemplary embodiment.

FIG. 6 is an exploded perspective view of a battery system according to an alternative embodiment.

FIG. 7 is an exploded perspective view of a battery system according to an alternative embodiment.

FIG. 8 is a perspective view of a battery system according to an alternative embodiment.

FIG. 9 is a schematic block diagram of a battery thermal management system according to an exemplary embodiment.

### DETAILED DESCRIPTION OF THE PREFERRED AND OTHER EXEMPLARY EMBODIMENTS

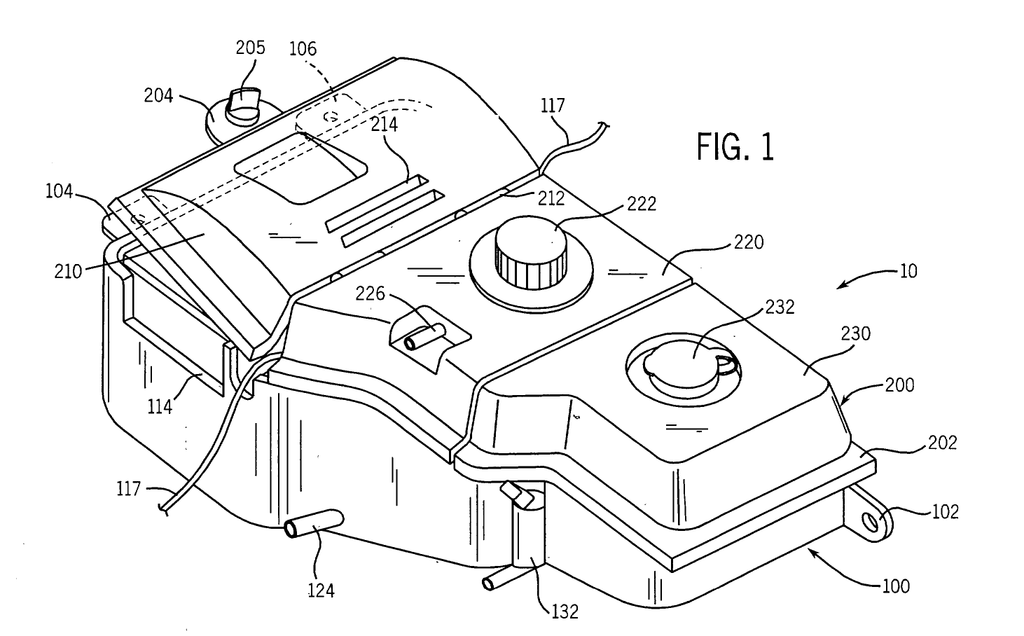

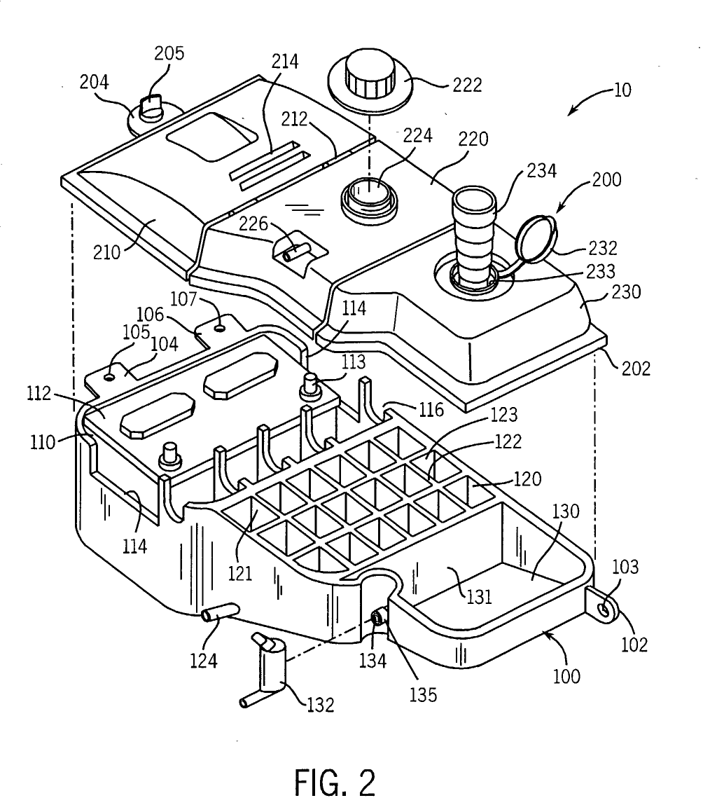

Referring to FIGS. 1 and 2, a battery module or system 10 includes a base or container portion 100 and a cover portion 200 attached or coupled to base portion 100 about a frame or rim 202. Base portion 100 includes two or more integral compartments that provide containment for a vehicle battery and one or more components (e.g., fluids such as liquids or gases, cables, wiring, etc.). Cover portion 200 includes two or more segments or portions that are positioned above the compartments included in base portion 100. A cover segment positioned above a battery compartment may be selectively positionable between an open position and a closed position with respect to the battery compartment.

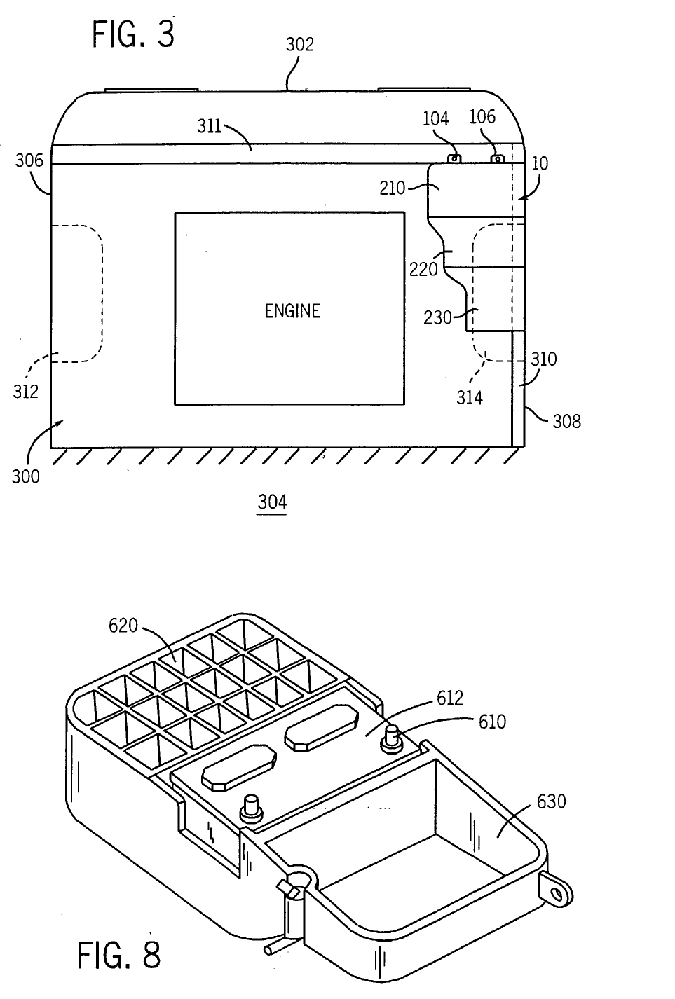

Module 10 is configured for use within a vehicle engine compartment 300, as shown in FIG. 3, and may be produced in a variety of shapes and sizes to fit within a given space within engine compartment 300. For example, as shown in FIG. 3, module 10 is positioned near the front 302 of engine compartment 300 along the right side 308. Module 10 is retained within engine compartment 300 by affixing or coupling module 10 to cross support member 311 and side bar 310 with a fastener. Module 10 is secured in place over or adjacent to wheel well 314. According to an alternative embodiment, a module may be positioned elsewhere in an engine compartment (e.g., along left side 306 and over or adjacent to wheel well 312, near passenger compartment 304, or anywhere else in engine compartment 300). According to an alternative embodiment, the module may be configured to be positioned within a vehicle trunk or passenger compartment in alternative embodiments.

As shown in FIGS. 1 and 2, base portion 100 includes a battery compartment or container 110, a first fluid compartment or container 120 (shown as a pressurized fluid compartment), and a second fluid compartment or container 130 (shown as a non-pressurized fluid compartment). Fluid compartments 120 and 130 act as storage or overflow reservoirs for a variety of liquids (e.g., radiator fluid, windshield washer fluid, power steering fluid, braking fluid, etc.). A wire harness 116 is also provided intermediate or between battery compartment 110 and pressurized fluid compartment 120 for providing a space or passage for utilities such as battery cables (i.e., cables that may be attached to battery terminals 113) or for other cables or wires associated with various vehicle engine components (e.g., electrical or communications wires or cables, etc.).

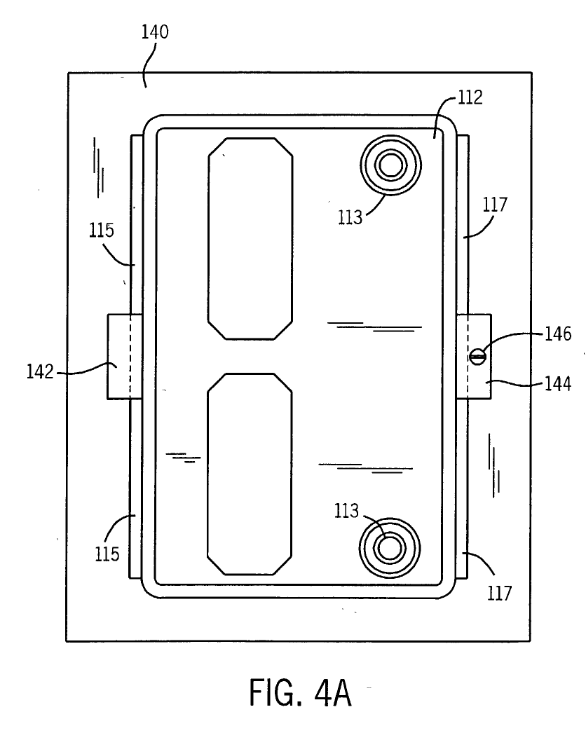

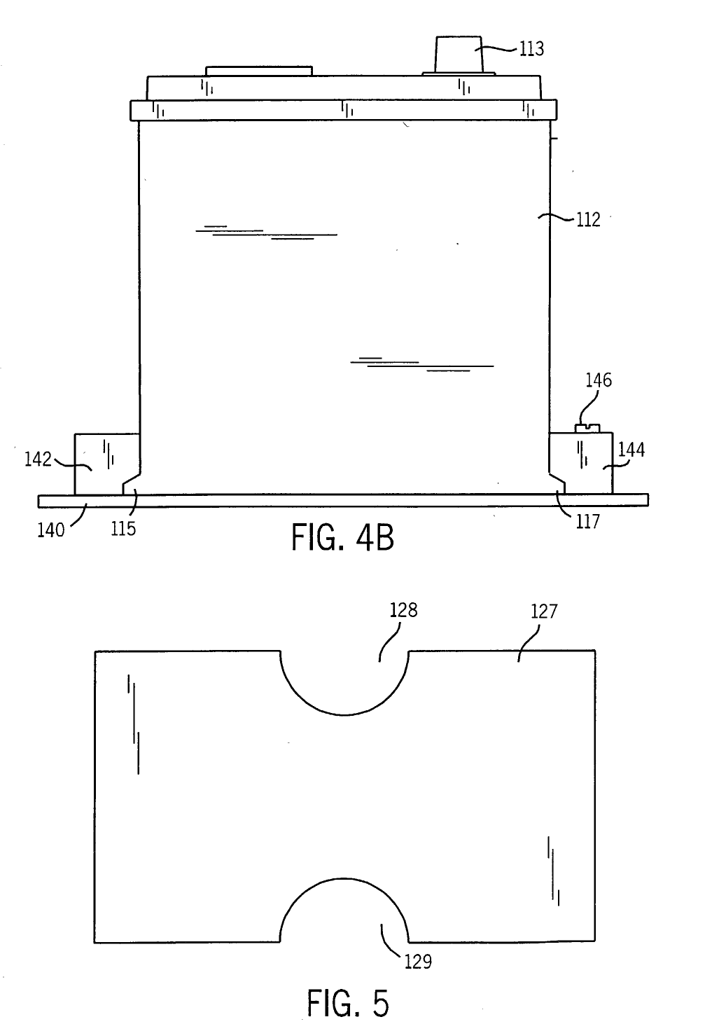

Battery compartment 110 includes several walls and a base or tray 140 (shown in FIGS. 4A and 4B) and is configured for containing or storing a vehicle storage battery 112. Tray 140 may be connected to the walls such that the tray and walls are integrally formed, such as by injection molding. According to an alternative embodiment, the tray and walls may be separate components that are assembled after each is produced. Cut-outs or vents 114 (e.g., outlets or passages, etc.) are provided in two walls of battery compartment 110 for venting gases that may be expelled or exhausted from battery 112 and to provide thermal management for the battery by allowing the exchange of air within battery compartment 110. Vents 114 may also serve as handles when cover portion 200 is attached to base portion 100 (e.g., cover portion 200 includes a frame extending outward from base portion 100, which may be gripped by an individual to carry or move cover portion 200 or module 10).

As shown in FIGS. 4A and 4B, battery compartment 110 includes first and second hold-downs or retention elements (shown as wedges or blocks 142 and 144) to secure or retain battery 112 in place. Hold-downs 142 and 144 have a geometry complementary to that of ribs or extensions 115 and 117 that are integral with and extend from battery 112. First hold-down 142 is relatively permanent attached to or integrally molded with battery tray 140. Second hold-down 144 is relatively non-permanently attached to battery tray 140 and is attached to battery tray 140 with a fastener 146 (e.g., a screw, pin, bolt, etc.) extending through hold-down 144 and into battery tray 140.

In operation, battery 112 is placed within battery compartment 110 by positioning extension 115 adjacent to hold-down 142 such that hold-down 142 engages extension 115 (e.g., hold-down 142 and extension 115 are in abutting relationship). This may be accomplished by inserting battery 112 into battery compartment 110 at an angle and rotating battery 112 into place, by inserting battery 112 straight down into battery tray 140 and sliding battery 112 into place, or by another method. After battery 112 is positioned within battery tray 140, hold-down 144 may be positioned in abutting relationship to extension 117 and secured using fastener 146. In this manner, battery 112 may be securely retained within battery compartment 110.

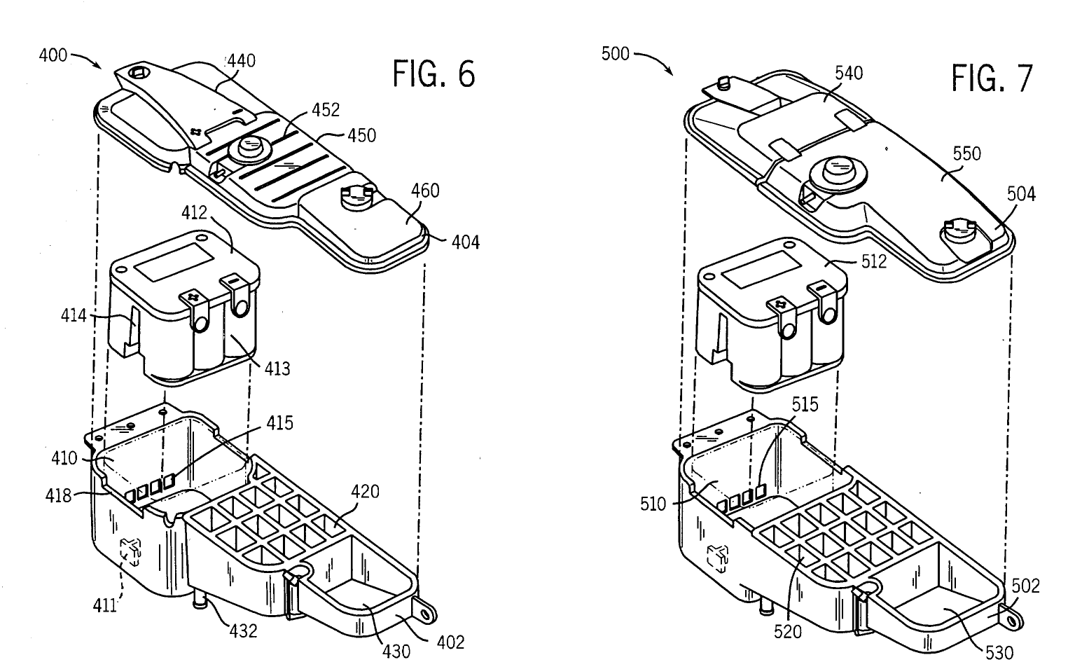

Other ways of securing a vehicle battery within a battery compartment may also be used. According to an alternative embodiment, as shown in FIG. 6, a spiral cell battery 412 is shown as having spaces 413 between adjacent battery cells. A channel or groove 414 may be provided in or adjacent to one of the spaces to engage a battery hold-down 411 that is integral with a battery compartment 410. In this embodiment, battery 412 may be inserted such that hold-down 411 automatically engages channel 414. Hold-down 411 may include features that are complementary to features provided in channel 414 such that the features in hold-down 411 mate with the features in channel 414 when battery 412 is positioned within battery compartment 410.

According to an alternative embodiment, other vehicle hold-down systems may also be implemented, including top hold-downs (e.g., a cross-bar or member is positioned across and in abutting relationship with the top of a battery to secure the battery in place). According to an alternative embodiment, a different number or configuration of hold-down may be used depending on a particular application. For example, four hold-downs (e.g., similar to hold-down 411 as shown in FIG. 6) may be provided (e.g., one for a channel formed in each of four sides of a battery). In another example, no hold-downs are provided, and a cover portion positioned above the battery compartment may be responsible for securing the battery in place.

Vents 114 may be any suitable shape or size for providing venting and/or thermal management of a battery. As shown in FIGS. 1 and 2, vents 114 are formed as rectangular cut-out portions located along the top of one or more walls of battery compartment 110. According to other alternative embodiments, the size or shape of the vents may differ. For example, a vent may have a generally circular shape or may have a smaller size (e.g., such as vent 418 shown in FIG. 6). The configuration and/or positioning of the vents may also vary depending on various design choices (e.g., one or more vents may be provided in the battery tray, may be implemented with an output tube connected to the battery compartment, etc.). According to an alternative embodiment, the number of vents provided in the battery compartment may differ. For example, while two vents are shown in FIGS. 1 and 2, a larger or smaller number of vents may be provided. According to another alternative embodiment, no vents are provided in the battery compartment (e.g., venting of the battery may be accomplished by a vent in the cover portion as shown in FIG. 1 as vent 214, etc.).

Wire harness 116 may include a series of semi-circular cut-outs 119 in ribs or extensions 118 integrally formed with battery compartment 110. A complementary semi-circular cut-out corresponding to each of cut-outs 119 may be present in a portion of cover 200 to provide a generally circular channel through which cables or wires may be positioned. According to other alternative embodiments, a wire harness may be implemented as a generally cylindrical tube, as an aperture formed in the module without any ribs or tubes for support, or any other type of harness for providing a pathway for vehicle wires or cables. While the wire harness is shown as being provided within the battery compartment in FIG. 2, a wire harness may be positioned elsewhere in the module according to alternative embodiments (e.g., between adjacent fluid compartments, on top of the cover, etc.).

The battery compartment may have a shape and size to accommodate any of a variety of different batteries having various configurations. According to an alternative embodiment, a battery compartment may be designed to allow insertion of only a specific type of battery. For example, a battery compartment may be designed with a ribbed wall to mate or couple with complementary grooves or notches formed in an exterior surface of a particular battery.

Cover portion 200 is divided into segmerits or sections that correspond to compartments provided in base portion 100. A battery cover portion or flap 210 (e.g., shown as a door in FIG. 1) corresponds to battery compartment 110, and is attached or coupled to the remainder of cover 200 or to battery compartment 110 by one or more hinges 212. Hinge 212 is shown in FIG. 1 as a mechanical hinge. According to an alternative embodiment, a living hinge may be used (e.g., an integral reinforced region configured to allow the battery cover portion to flexibly rotate about the hinge). Thus, battery cover portion 210 may be selectively positioned in relation to battery 112 and battery container 110 to allow for convenient access to battery 112. According to an alternative embodiment, the battery cover portion may be completely removable from battery compartment. One or more extensions or protrusions (not shown) may extend from an inner surface of the battery cover portion to engage a top surface of the battery to more securely hold the battery in place. According to a preferred embodiment, the protrusions have an “X” or “cross” shape. Other shapes or configurations may be used in other alternative embodiments.

Battery cover portion 210 includes a rim or frame section 202 configured for removable attachment to battery compartment 110. Rim 202 allows for non-invasive attachment of the battery cover to the battery compartment, and may be implemented in any suitable manner (e.g., snap-fit, etc.). As shown in FIGS. 1 and 2, an extension 204 (e.g., a tab or flange) is provided for securing battery cover portion 210 to base portion 100 and/or to battery compartment 110 or another location such as cross-member 311 in engine compartment 300. Extension 204 includes an aperture for receiving a fastener 205 (e.g., a bolt, screw, pin, quarter-turn fastener, etc.) for securing the extension (and hence battery cover portion 210) to base portion 100, battery compartment 110, or another location. To access battery 112, fastener 205 is unscrewed or loosened to allow battery cover portion 210 to rotate about hinge 212. To secure battery cover portion 210 in place, battery cover portion 210 is rotated about hinge 212 toward battery 112 and fastened in place using fastener 205.

Battery cover portion 210 may include one or more vents 214 designed to allow venting (e.g., escape or expulsion of gases and/or exchange of air within battery compartment 110). The vents may be formed as slits or apertures, or may have any other suitable size, shape, configuration, or arrangement. Any number of vents may be used, depending on the particular application. According to an alternative embodiment, the battery cover portion may include a mesh, web, or screen portion (not shown) configured to act as a vent for gases.

The battery compartment may be large enough to entirely contain the battery within the compartment or may contain only a bottom portion of the battery. The battery cover portion may be substantially planar or may have a raised or vaulted configuration adapted to contain a top portion of the battery or to provide space between the battery and the battery cover portion. A raised or vaulted portion may provide a space between the battery and the battery cover portion to allow thermal management of the battery, such that heat from the engine compartment does not damage or otherwise shorten the life of the battery.

As shown in FIGS. 1 and 2, battery compartment 110 is contiguous or immediately adjacent to pressurized fluid compartment 120, which is configured to contain a pressurized fluid such as a liquid (e.g., excess radiator fluid) or gas (e.g., the compartment may act as a vacuum assist for mechanical or hydraulic systems in a vehicle, such as cruise control, steering, or braking systems, such that a negative pressure is maintained within the compartment that may be used to assist the mechanical or hydraulic systems). Wall or panel 121 separates battery compartment 110 from pressurized fluid compartment 120. Pressurized fluid compartment 120 also includes a number of walls and a bottom panel, which may be integrally formed (e.g., by injection molding) with the walls to substantially prevent fluid leakage.

Pressurized fluid compartment 120 includes a number of baffles or walls 122 (e.g., dividers, partitions, etc.) configured to provide structural strength or reinforcement for compartment 120. Baffles 122 may be arranged as a series of walls to form a generally grid-like structure and may include apertures or cut-outs to allow fluid to flow within the grid-like structure. For example, a series of rectangular cells or openings 123 may be formed by arranging baffles substantially perpendicular to one another. According to an alternative embodiment, other configurations or arrangements of baffles may be utilized, depending on the particular application and strength desired.

FIG. 5 shows a front elevational view of a baffle 127 according to an alternative embodiment. Baffle 127 includes a generally semi-circular top cut-out or aperture 128 and a bottom cut-out or aperture 129. Cut-outs 128, 129 are designed to allow fluid flow between adjacent cells or openings. In a preferred embodiment as shown in FIG. 1, no top cut-outs are provided in baffles 122. Baffles 122 only include bottom cut-outs (not shown) according to a preferred embodiment. According to an alternative embodiment, both top and bottom cut-outs are provided. According to other alternative embodiments, the size, shape, position, and configuration of cut-outs provided in the baffles may vary (e.g., a generally circular cut-out may be provided in a baffle, cut-outs may be provided at the sides of baffles, etc.).

Baffles 122 may be integrally formed (e.g., injection molded) with the walls of pressurized fluid compartment 120 to provide added structural rigidity. According to alternative embodiments, the pressurized fluid compartment may include other structural elements, such as ribs or thickened material regions, that are designed to provide added strength and rigidity.

An opening or return tube 124 is coupled to pressurized fluid compartment 120 to allow fluid to exit the fluid compartment as through a channel or passage. For example, opening 124 may act as a return tube to transfer radiator fluid to a vehicle radiator. Opening 124 may include a cylindrical tube having a proximal end and an opening into the fluid compartment. The tube may be integrally molded as a part of the fluid compartment wall or may be inserted after formation of the fluid compartment.

Cover 200 includes a pressurized fluid compartment cover portion 220 configured to complement pressurized fluid compartment 120 to form a first fluid chamber. The pressurized fluid compartment cover portion includes a number of baffles (not shown) that are configured to provide structural rigidity. The pressurized fluid compartment cover portion need not include the same number and configuration of baffles as included in pressurized fluid compartment 120 (e.g., the baffled cover portion may include a lesser or greater number of baffles and the individual baffles may have a different size, pattern, or arrangement). The baffles in the pressurized fluid compartment cover portion may include apertures or cut-outs designed to allow fluid flow between adjacent cells created by the baffles. According to an alternative embodiment, baffles are not provided in the pressurized fluid compartment cover portion.

Pressurized fluid compartment cover portion 220 includes an opening or aperture which allows fluid (e.g., radiator fluid or coolant) from an external source to enter the interior of pressurized fluid compartment 120 and its corresponding cover portion 220. An overflow tube or member 226 may be integrally formed with pressurized fluid compartment cover portion 220, or may be separately produced and attached to the pressurized fluid compartment cover portion.

Pressurized fluid compartment cover portion 220 may also include an aperture or fill hole 224 configured to allow fluid to be introduced into pressurized fluid compartment 120 and its corresponding cover portion 220. Fill hole 224 may be formed as a threaded cylinder extending from the top surface of pressurized fluid compartment cover portion 220 and configured to receive a complimentary threaded fluid compartment cap or cover 222. According to an alternative embodiment, the fill hole may be formed as a generally smooth cylindrical member extending from the top surface of the cover portion. The smooth cylinder may include a rib about its circumference or a similar structure configured to mate with a complementary structure in a fluid compartment cap (e.g., the cap could “snap” onto the cylinder).

The pressurized fluid compartment cover portion may be permanently secured to the pressurized fluid compartment by a fastener such as a heat seal, glue, or any other acceptable fastener. A permanent seal substantially prevents fluid from escaping from the chamber formed between compartment 120 and cover portion 220 during vehicle operation.

Non-pressurized fluid compartment 130 is contiguous or immediately adjacent to pressurized fluid compartment 120 and separated therefrom by wall or panel 131. Non-pressurized fluid compartment 130 is configured to provide containment of non-pressurized fluids (e.g., windshield wiper fluid, etc.). As with pressurized fluid compartment 120, the non-pressurized fluid compartment includes a number of walls and a bottom panel integrally formed with the walls (e.g., as by injection molding) to substantially prevent fluid leakage.

An opening or aperture 134 is provided in a wall to act as a channel or passage through which material such as a fluid may enter or exit non-pressurized fluid compartment 130. Opening 134 is configured to receive an extension or pipe from a subsystem such as a washer fluid pump 132. For example, washer fluid contained within non-pressurized fluid compartment 130 may be pumped from the fluid compartment to another location in the vehicle, such as a sprayer unit designed to spray washer fluid onto a windshield. Opening 134 may be fitted with a washer or seal 135 (e.g., a rubber seal or washer) configured to prevent uncontrolled leakage of the fluid from opening 134. For example, a washer may be fitted in the opening and a washer fluid pump may be inserted in the aperture, such that fluid does not escape from a gap between the washer fluid pump and the opening.

The walls of non-pressurized fluid compartment 130 may be formed so as to receive therein a subsystem illustrated in the FIGURES as a fluid pump 130. For example, a wall of the fluid compartment may include a concave or semi-circular molded portion 133 in which fluid pump 132 may be attached or received.

Cover 200 includes a non-pressurized fluid compartment cover portion 230 that does not include reinforcing baffles. Non-pressurized fluid compartment cover portion 230 is relatively permanently attached to the non-pressurized fluid compartment 130 (e.g., in a manner similar to that described above with respect to pressurized fluid compartment cover portion 220) to form a second fluid chamber and to substantially prevent fluid leakage during vehicle operation.

An aperture 233 is provided in non-pressurized fluid compartment cover portion 230 to allow introduction of fluids (e.g., windshield washer fluid) into non-pressurized fluid compartment 130. A funnel or tube 234 is provided to allow introduction of fluids through aperture 233. Funnel 234 may be implemented as a telescoping or selectively retractable funnel that extends from a top surface of non-pressurized fluid compartment cover portion 230 to provide a raised and widened opening for introducing fluid. Funnel 234 may then be collapsed and contained within non-pressurized fluid compartment cover portion 230 when not in use. A cap or cover 232 is provided as a cover for the opening in non-pressurized fluid compartment cover portion 230, and may either be threaded or non-threaded as described above with respect to cap 222. According to an alternative embodiment, no funnel is provided (e.g., only an aperture is provided to allow fluids to be introduced into the non-pressurized fluid compartment). According to another alternative embodiment, the non-pressurized fluid compartment includes a low-level fluid sensor to indicate that fluid should be added to the compartment.

Pressurized fluid compartment 120 and non-pressurized fluid compartment 130 may act as heat exchangers for battery 112, such that fluid held or contained within the fluid compartments 120, 130 provides thermal regulation (e.g., heating or cooling) for battery 112 by thermal conduction. For example, in cold weather, heated fluid (e.g., radiator fluid) contained in pressurized fluid compartment 120 may act to warm the temperature of battery 112. In warm weather, fluid contained in non-pressurized fluid compartment 130 (e.g., windshield washer fluid) may act as a heat sink to cool the temperature of battery 112. Walls of module 10 may also provide a thermal barrier (e.g., insulation) between battery 112 and the remainder of vehicle engine compartment 300 to promote heating and cooling of battery 112.

In general, heat may be exchanged or transferred between battery storage compartment 110 and one or more of the fluid compartments 120 and 130 or the surrounding atmosphere (e.g., under-hood environment). Module 10 may be configured to facilitate heat transfer (e.g., conduction, radiation, convection, etc.) to heat or cool battery 112. For example, battery 112 may be cooled by convection of air from battery compartment 110 to the atmosphere through vents 114 and 214. Battery 112 may also be warmed by convection of warm air from the vehicle engine in cold weather. According to an alternative embodiment, a battery compartment may be provided with a number of fins or flanges to provide space between the battery and the walls of the battery compartment to enhance air flow and cooling of the battery.

To quickly and conveniently install module 10 within engine compartment 300, base portion 100 includes a number of extensions or vehicle mounts 102, 104, 106 (illustrated in the FIGURES as tabs or flanges) having holes or apertures 103, 105, 107. Fasteners (e.g., bolts, screws, pins, etc.) may be inserted through apertures 103, 105, and 107 and through a corresponding hole or aperture in cross member 311 and side bar 310 (or another location within engine compartment 300 or within a vehicle trunk or passenger compartment) to secure module 10 in place.

As shown in FIG. 2, vehicle mounts 104 and 106 are positioned adjacent to the exterior of battery compartment 110 and vehicle mount 102 is positioned adjacent to non-pressurized fluid compartment 130. The position, size, shape, number, and arrangement of vehicle mounts may vary in alternative embodiments.

Vehicle mounts 102, 104, and 106 may be integrally molded with base portion 100 such that vehicle mounts 102, 104, and 106 and base portion 100 comprise a single piece. According to an alternative embodiment, vehicle mounts may be produced separately and attached to the base portion.

The various compartments (e.g., battery compartment 110, pressurized fluid compartment 120, non-pressurized fluid compartment 130, wire harness 116, etc.) may be arranged in any suitable manner. For example, according to an alternative embodiment, a battery compartment may be adjacent to a fluid compartment without structural reinforcements (e.g., baffles), which in turn may be adjacent to a compartment having structural reinforcements. In another embodiment, one or more fluid compartments may be arranged or positioned so as to provide a buffer or barrier between the battery and the engine or engine compartment.

According to an alternative embodiment as shown in FIG. 6, a base portion 402 includes a battery compartment 410, a pressurized fluid compartment 420, and a second fluid compartment 430. A cover 404 is provided that includes a battery compartment cover portion 440, a pressurized fluid compartment cover portion 450, and a non-pressurized fluid compartment cover portion 460. A return tube 432 is shown as extending from a bottom surface of pressurized fluid compartment 420, as opposed to extending from one of the lateral walls of the compartment. Unlike battery compartment cover portion 210, battery compartment cover portion 440 does not include vents to allow battery gases to escape. Gases instead may escape through openings 418 provided in a wall of the battery compartment. Portion 440 also is attached to the remainder of cover 440 by a conventional mechanical hinge, as opposed to an integrally molded living hinge. Pressurized fluid compartment cover portion 450 includes a number of ribs or protrusions 452 extending from the top surface of cover 404. Ribs or protrusions 452 may be provided to enhance mechanical strength of the cover or to provide some other function. The ribs may extend in any direction and may have a size and shape that varies in alternative embodiments, and may be provided on one or more of the various portions of the cover.

According to an alternative embodiment as shown in FIG. 7, a base portion 502 includes a battery compartment 510, a pressurized fluid compartment 520, and a second fluid compartment 530. A cover 504 is provided that includes a battery compartment cover portion 540 and a cover portion 550 that is shared between pressurized fluid compartment 520 and second fluid compartment 530. The underside of cover 504 may include a projection (not shown) that acts to separate chambers formed corresponding to first and second fluid compartments 520, 530 so that fluid from one compartment does not enter another compartment. Cover portion 550 may improve aesthetic appeal of the module shown in FIG. 7 by having the appearance of a single cover associated with two separate fluid compartments.

According to an alternative embodiment as shown in FIG. 8, a battery compartment 610 is positioned intermediate or between a reinforced fluid compartment 620 and a non-reinforced fluid compartment 630. In this manner, thermal conduction between battery compartment 620 and adjacent fluid compartments 620 and 630 may provide for enhanced thermal management for a battery 612 positioned within battery compartment 620 (i.e., heat transfer to and from battery 612 may be accomplished by providing fluid compartments adjacent battery compartment 620 that allow conductive heat transfer to and from battery compartment 620). In this manner, one fluid compartment may act as a heat sink for the battery compartment (e.g., in warm weather) and the other fluid compartment may provide warmth to the battery compartment (e.g., in cold weather) to maintain substantially predictable battery performance. An appropriate cover design may be provided to allow access to the various compartments. For example, a battery cover portion may be provided that is either attached by hinges to the remainder of the cover or directly to the battery compartment. According to an alternative embodiment, the battery cover portion may be completely removable from the battery compartment, such as by utilizing a snap-fit design for the battery cover portion.

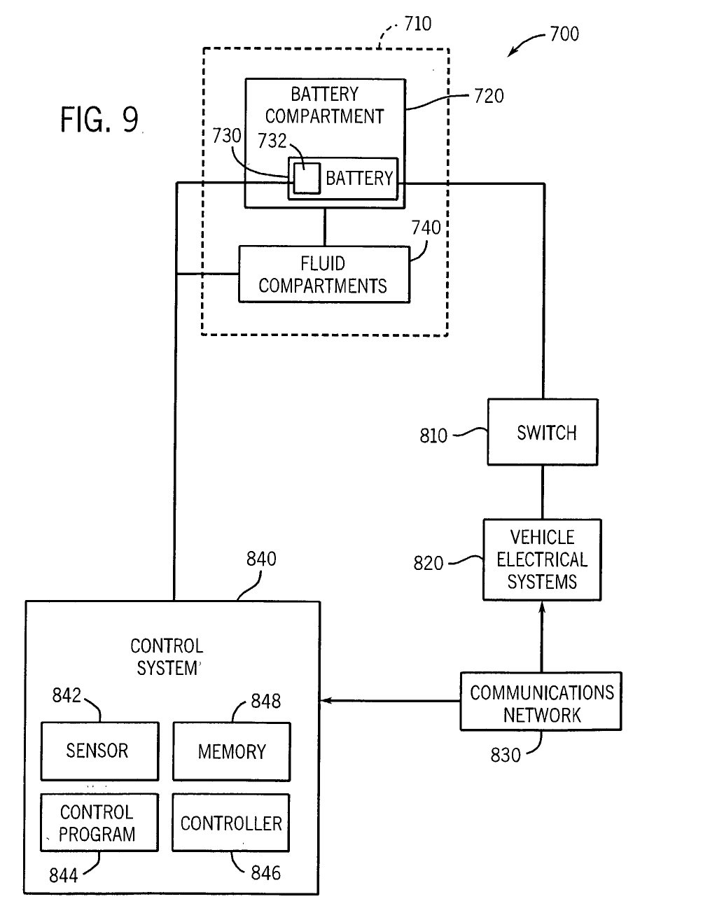

Referring to FIG. 9, a schematic block diagram of a battery thermal management system 700 for a vehicle battery 730 is shown. System 700 includes a module 710 having compartments 740 for containing fluids in thermal communication with a compartment 720 for battery 730. Battery 730 includes a temperature monitor or sensor 732 configured to monitor at least one of the surface temperature of battery 730 and the ambient temperature within battery compartment 710. Temperature sensor 732 may be implemented as a thermistor, a thermocouple, or other temperature measuring device, and may be coupled to or packaged with an electronics module (e.g., a battery state of charge or state of health monitor) provided on battery 730 or within compartment 720. Measurements received from temperature sensor 732 may be used to infer the internal temperature of battery 730 using algorithms or other methods.

Battery 730 is selectively connected and disconnected from vehicle electrical systems 820 (e.g., air conditioning systems, lighting systems, starting and ignition systems, etc.) by a device or switch 810. Information relating to the status or condition of vehicle electrical systems 820 is provided to a control system 840 through a communications network 830 (e.g. e.g. CAN bus, J1850, LIN, etc).

Control system 840 includes a controller 846 for running a control program 844 stored in a memory 848. Control system 840 monitors, regulates and controls vehicle and battery parameters and conditions. Control system 840 also includes sensors 842 (which can be the same as sensor 732) for monitoring a condition of battery 730 such as a temperature of compartment 720 and for providing a signal to control system 840 that is representative of the monitored condition. Control system 840 can control the temperature of compartment 720 and battery 730 by selective manipulation of fluids included in compartments 740. For example, when control system 842 identifies that battery 730 is at a temperature above or below a threshold value (based on information received from temperature sensor 732), control system 840 can instruct that heated or cooled radiator liquid (or air or another fluid) be provided to one of the compartments 740 to heat or cool battery 730 (i.e. thermal management of the battery). Such selective introduction of fluids into the fluid compartments may be accomplished using a mechanical system (not shown) to open or close channels that allow flow of fluid between the fluid compartments and various vehicle subsystems (e.g., a radiator, a windshield washer mechanism, etc.).

The control system may be a microprocessor, controller or programmable logic chip (PLC) for implementing a control program and which provides output signals based on input signals provided by a sensor or that are otherwise acquired. According to alternative embodiments, other suitable controllers of any type may be included in the control system. For example, controllers of a type that may include a microprocessor, microcomputer or programmable digital processor, with associated software, operating systems and/or any other associated programs to collectively implement the control program may be employed. According to alternative embodiments, the controller and its associated control program may be implemented in hardware, software or a combination thereof, or in a central program implemented in any of a variety of forms. According to an alternative embodiment, a single control system may regulate the controller for the control system and the controller for the vehicle.

Other modifications are also possible. For example, two or more structurally reinforced (e.g., having baffles or other structures) or non-structurally reinforced fluid compartments may be provided in a battery module, depending on the particular application. As mentioned previously, the location of the utility or wire harness may also differ in alternative embodiments.

Each of the compartments included in the base portion may be sized and shaped in a variety of ways, depending on various design considerations. The compartments may be designed to fit within a particular space in a vehicle engine compartment. For example, the battery compartment may be arranged so that the long side of the battery compartment may extend along the front of the vehicle. In another configuration, the long side of the battery compartment may extend along the side of the vehicle. Similarly, the fluid compartments may be molded in any manner which allows the entire base portion to fit within a given space in the engine compartment or to satisfy other design criteria. For example, in certain situations it may be desirable to have a taller fluid compartment having a reduced area. In other situations it may be advantageous to have a shorter compartment with a larger area.

The number and shape of the baffles included in pressurized fluid compartments may vary. Depending on the size of the fluid compartment and the strength required to maintain structural rigidity of the compartment, various designs may be utilized.

The entire base portion, including the battery compartment, one or more fluid compartments, and vehicle mounts for securing the base portion to the vehicle engine interior, may be integrally formed as a single piece. For example, the entire base portion may be formed of a polymeric material such as plastic and injection molded in a single operation. According to an alternative embodiment, one or more components of the base portion may be formed separately and attached to the other various components to form the base portion.

The battery may be any type of battery or power source. According to a particularly preferred embodiment, the battery is an automotive vehicle battery or battery pack such as a 12V or 36V SLI battery. A suitable 12V battery includes an absorptive glass mat (AGM) Optima battery commercially available from Optima Batteries, Inc. of Boulder, Colo. Another suitable 36V battery includes a 2.4 amp hour Inspira battery commercially available from Johnson Controls Battery Group, Inc. of Milwaukee, Wis.

Various materials may be used to form the various components (e.g., cover, fluid compartments, battery compartments, etc.), including various polymers, metals, and metal alloys. For example, in an exemplary embodiment, the base portion and cover may be made from a polymeric material such as polyethylene, polypropylene, a variety of copolymers, and the like. According to an alternative embodiment, a battery tray may be provided that includes metal (e.g., aluminum, magnesium, steel, etc.). It is generally preferred that wire harness be made of a polymeric material, as non-conductive materials are best suited for this application to avoid current loss from wires or cables. Composite materials (e.g., glass fiber reinforced polypropylene, chopped Kevlar™ reinforced polyethylene, etc.) may also be used for the base portion or cover. Materials used for the various components may also differ (e.g., baffles may be made of a different material than the surrounding fluid compartment; adjacent compartments may be made of different materials; caps and funnels may use a different material than the cover; fasteners may be made of tool steel, stainless steel, polymers, etc.). Portions of the module may also use recycled materials, such as recycled polymeric materials. For example, the base portion may be made from recycled plastic while the cover may be made from original or new plastic.

It is important to note that the construction and arrangement of the elements of the battery and fluid module as shown in the preferred and other exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements (e.g., vehicle mounts may be attached to the base portion), the position of elements may be reversed or otherwise varied (e.g., the battery compartment may be sandwiched between two fluid compartments), and the nature or number of discrete elements or positions may be altered or varied (e.g., three or more fluid compartments rather than two may be provided in the battery and fluid module). It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit and scope of the present invention.

What is claimed is:

1. A module for use in a vehicle comprising:
a first compartment for containing a battery; and
a second compartment contiguous to the first compartment for containing a liquid and configured for routing the liquid between the second compartment and a vehicle subsystem.

2. The module of claim 1, wherein the liquid comprises at least one of radiator fluid, braking fluid, windshield washer fluid, and power steering fluid.

3. The module of claim 1, wherein the vehicle subsystem is a radiator.

4. The module of claim 1, wherein the vehicle subsystem is a windshield washer.

5. The module of claim 2, wherein the second compartment is configured to contain a pressurized liquid.

6. The module of claim 5, wherein the liquid provides for the transfer of heat between the first compartment and the second compartment.

7. The module of claim 6, further comprising a cover and a base, wherein the base comprises the first compartment and the second compartment.

8. The module of claim 7, wherein the cover includes a door coupled to the first compartment and selectively positionable between an opened position and a closed position relative to the base.

9. The module of claim 7, wherein the cover includes an aperture for introducing the liquid into the second compartment.

10. The module of claim 7, further comprising a harness for routing utilities.

11. The module of claim 7, wherein the second compartment includes at least one reinforcing element to provide strength to the second compartment.

12. The module of claim 11, wherein the second compartment includes a plurality of baffles arranged to form a plurality of cells.

13. The module of claim 12, wherein a plurality of the baffles having a cutout to allow liquid to flow between the plurality of cells.

14. The module of claim 7, wherein the first compartment includes a locking mechanism for retaining the battery.

15. The module of claim 14, wherein the locking mechanism comprises a battery tray.

16. The module of claim 7, further comprising a third compartment contiguous to at least one of the first compartment and the second compartment for containing a second liquid and for routing the second liquid to a vehicle subsystem.

17. The module of claim 16, wherein the first compartment is provided intermediate the second compartment and the third compartment.

18. The module of claim 16, wherein the second compartment is provided intermediate the first compartment and the third compartment.

19. A heat exchange system for a vehicle battery comprising:
a first compartment for containing the vehicle battery;
a second compartment for containing a first fluid and coupled to the first compartment;
a third compartment for containing a second fluid and coupled to at least one of the first compartment and the second compartment;
wherein at least one of the first fluid and the second fluid provides for heat transfer between the first compartment and at least one of the second compartment and the third compartment.

20. The heat exchange system of claim 19, wherein at least one of the first fluid and the second fluid is a liquid.

21. The heat exchange system of claim 20, wherein the liquid includes at least one of a windshield washer fluid, a braking fluid, a power steering fluid, and a radiator fluid.

22. The heat exchange system of claim 19, further comprising a cover coupled to the first compartment, the second compartment, and the third compartment.

23. The heat exchange system of claim 22, further comprising a vent in at least one of the first compartment and the cover.

24. The heat exchange system of claim 22, wherein the cover includes a battery cover segment and a fluid compartment segment, the battery cover segment coupled to the fluid compartment segment by a hinge.

25. The heat exchange system of claim 24, wherein the fluid compartment segment is relatively permanently attached to the second compartment and the third compartment.

26. The heat exchange system of claim 19, wherein the second compartment is configured to transfer heat from the second compartment to the vehicle battery.

27. The heat exchange system of claim 19, wherein the second compartment provides a heat sink for the vehicle battery.

28. A system for a vehicle battery comprising:
a base comprising:
means for containing the battery; and
means for containing a liquid coupled to the means for containing a battery; and
covering means coupled to the base.

29. The system of claim 28, wherein the liquid is a pressurized liquid.

30. The system of claim 29, wherein the means for containing a liquid includes a reinforcing means.

31. The system of claim 28, wherein the means for containing a liquid is configured for routing the liquid to a vehicle subsystem.

32. The system of claim 31, wherein the vehicle subsystem is at least one of a radiator and a windshield washer mechanism.

33. The system of claim 28, wherein the means for containing the battery and the means for containing a liquid are integrally molded as a single piece.

34. The system of claim 28, wherein the covering means includes a first cover portion and a second cover portion, the first cover portion positioned adjacent to the means for containing a battery.

35. The system of claim 34, wherein the first cover portion is coupled with a hinge to one of the second cover portion and the means for containing a battery.

36. The system of claim 28, wherein the means for containing a battery includes a battery tray having at least one hold-down for securing the vehicle battery.

37. The system of claim 28, further comprising filling means for introducing the liquid into the means for containing a liquid.

38. The system of claim 37, wherein the filling means comprises at least one of an aperture, a tube, and a funnel.

39. The system of claim 28, wherein at least one of the covering means and the means for containing a battery includes a vent.

40. The system of claim 28, further comprising means for containing a gas contiguous to at least one of the means for containing a battery and the means for containing a liquid.

41. The system of claim 40, wherein the means for containing a gas may be used as a vacuum assist for a vehicle system.

42. The system of claim 28, further comprising means for containing a second liquid coupled to at least one of the means for containing a battery and the means for containing a liquid.

43. The system of claim 42, wherein heat is transferred between the means for containing a battery and at least one of the means for containing a liquid and the means for containing a second liquid.

44. A battery module comprising:
a battery container for containing a vehicle battery; and
a plurality of compartments, each of the compartments adapted to contain a liquid;
wherein at least one of the plurality of compartments is immediately adjacent to the battery container.

45. The battery module of claim 44, wherein heat is transferred between the battery container and at least one of the plurality of compartments.

46. The battery module of claim 44, wherein the battery container and plurality of compartments are integrally formed as a single piece.

47. The battery module of claim 46, wherein the battery container and plurality of compartments comprise a polymeric material.

48. The battery module of claim 44, wherein the plurality of compartments include a first compartment for containing a first liquid and a second compartment for containing a second liquid.

49. The battery module of claim 48, wherein at least one of the first compartment and the second compartment includes a plurality of baffles.

50. The battery module of claim 48, wherein the first liquid comprises a radiator fluid and the second liquid comprises a washer fluid.

51. The battery module of claim 44, wherein two of the plurality of compartments are immediately adjacent to the battery container.

52. The battery module of claim 44, further comprising a cover provided over the battery container and the plurality of compartments.

53. The battery module of claim 52, wherein the cover includes a first cover portion and a second cover portion, the first cover portion being movable between a first position and a second position and coupled to at least one of the second cover portion and the battery container by a hinge.

54. The battery module of claim 52, further comprising a vent formed in at least one of the battery container and the first cover portion, whereby the vent provides thermal management of the battery.

55. The battery module of claim 52, wherein the cover includes an aperture for providing liquid into one of the compartments.

56. The battery module of claim 44, further comprising means for transferring liquid between at least one of the compartments and a vehicle system.

57. The battery module of claim 44, wherein the means for transferring liquid comprises at least one of an opening, a return tube, and a pump.

58. The battery module of claim 44, further comprising a wire harness coupled to the battery container.
